(19) United States
(12) Patent Application Publication
(10) Pub. No.: US 2024/0040315 A1
(43) Pub. Date: Feb. 1, 2024

(54) HEARING ASSISTIVE DEVICES

(71) Applicant: MCK Audio, Inc., Elk Grove Village, IL (US)

(72) Inventors: Mead Killion, Elk Grove Village, IL (US); Frank Dunn, Austin, TX (US); Andrew Haapapuro, Arlington Heights, IL (US); Stephen Julstrom, Chicago, IL (US); Viorel Drambarean, Lincolnwood, IL (US)

(21) Appl. No.: 18/361,773

(22) Filed: Jul. 28, 2023

Related U.S. Application Data
(60) Provisional application No. 63/392,977, filed on Jul. 28, 2022.

(51) Int. Cl. H04R 5/033; H04R 25/00; H04R 3/14

(52) U.S. Cl. CPC H04R 5/033; H04R 25/554; H04R 3/14; H04R 2420/07; H04R 2225/55

(57) ABSTRACT

A communication system for hearing device users is disclosed. The communication system includes a communication device configured to convert sound to an electrical audio signal combined with other electrical audio signals from other communication devices; a communication module to receive the electrical audio signal to generate a communication signal and transmit the communication signal using a communication protocol; and one or more hearing devices configured to receive the communication signal using the communication protocol. Other aspects, embodiments, and features are also claimed and described.

### CROSS REFERENCE TO RELATED APPLICATIONS

This application claims the benefit of U.S. Provisional Application 63/392,977, filed Jul. 28, 2022.

### TECHNICAL FIELD

The technology discussed below relates generally to hearing assistive devices.

### SUMMARY

The following presents a simplified summary of one or more aspects of the present disclosure, to provide a basic understanding of such aspects. While some examples may be discussed as including certain aspects or features, all discussed examples may include any of the discussed features. Unless expressly described, no one aspect or feature is essential to achieve technical effects or solutions discussed herein.

In one example, an inductive loop pad includes a cover pad, and one or more wires in the cover to generate an electromagnetic field for a hearing device to generate an audio signal based on the electromagnetic field.

In another example, a communication system includes a communication device configured to convert sound to an electric signal; an amplifier configured to convert the electric signal to electric current and transmit the electric current; an inductive pad electrically coupled with the amplifier, the inductive pad comprising a cover pad and one or more wires configured to generate an electromagnetic field based on the current; and a hearing device configured to generate an audio signal based on the electromagnetic field. Other aspects, embodiments, and features are also claimed and described.

In a further example, a communication system includes a communication device configured to convert sound to an electrical audio signal; a communication module to receive the electrical audio signal to generate a communication signal and transmit the communication signal using a communication protocol; and one or more hearing devices configured to receive the communication signal using the communication protocol.

These and other aspects of the inductive loops for hearing device users and their related wireless communication devices discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various tools, devices, systems, and methods.

### BRIEF DESCRIPTION OF THE DRAWINGS

FIG. 1 is a conceptual illustration of an example of a communication system using an inductive loop pad according to some embodiments.

FIGS. 2A-2C are conceptual illustrations of examples of a communication system installed on a table according to some embodiments.

FIG. 3 is a conceptual illustration of an example of a communication system installed on multiple tables according to some embodiments.

FIG. 4A is a conceptual illustration of an example of a communication system using a communication protocol according to some embodiments.

FIG. 4B is a conceptual illustration of another example of a communication system using a communication protocol according to some embodiments.

FIG. 4C is a conceptual illustration of another example of a communication system using a communication protocol according to some embodiments.

FIG. 5 is a conceptual illustration of an example of a communication system using a phone according to some embodiments.

FIG. 6 is a conceptual illustration of an example of a communication system using a transmitter according to some embodiments.

FIG. 7 is a comparison of signal-to-noise ratio (SNR) for the disclosed communication system with other existing hearing devices.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

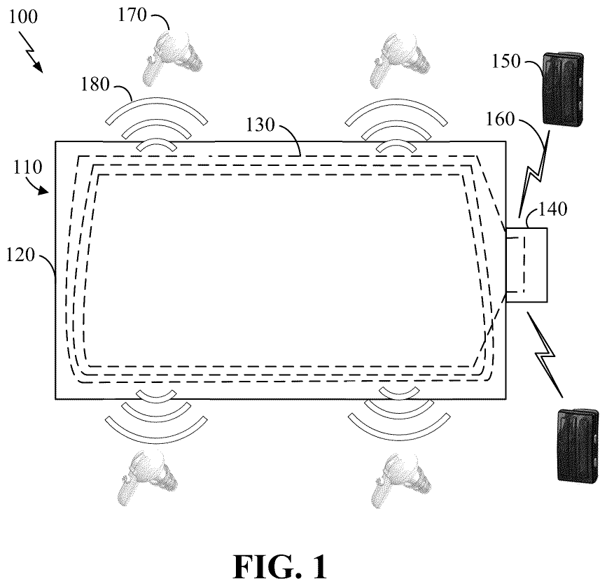

FIG. 1 is a conceptual illustration of an example of a communication system 100 using an inductive loop pad 110 according to an aspect of the disclosure. A communication system 100 can include an inductive loop pad 110, a power amplifier 140, one or more communication devices 150, and one or more hearing devices 170. For example, a communication device 150 can receive sound and convert sound to an electrical audio signal 160. An inductive loop pad 110 can receive the electrical audio signal 160 and generate an electromagnetic field 180 corresponding to the electrical audio signal 160. A hearing device 170 can receive the electromagnetic field 180 and convert the electromagnetic field 180 to the sound. Thus, a person wearing the hearing device 170 in his/her ear can hear the sound received by the communication device 150. The more detailed description for each component of the communication system 100 is presented below.

In some examples, an inductive loop pad 110 can include a cover pad 120 and one or more wires 130 to generate an electromagnetic field 180 in the cover pad 120. For example, the cover pad 120 can have a rectangular shape. In a non-limiting example, the dimensions of the cover pad 120 can be 36 inches by 20 inches (36″×20″). However, it should be appreciated that the shape of the cover pad 120 is not limited to the example above. For example, the cover pad 120 can have any suitable shape (e.g., square, circle, oval, or any other suitable shape for a hearing device 170 to sufficiently receive an electromagnetic field from the inductive loop pad 110). Furthermore, the size of the cover pad 120 is not limited to the dimensions of 36 inches by 20 inches. For example, the cover pad 120 can have any suitable size to cover a table. Also, the cover pad 120 can be small enough for a person to carry but large enough to generate an electromagnetic field for a hearing device to sufficiently convert the electromagnetic field to sound. In some instances, the cover pad 120 can be made of polyvinyl chloride. However, the cover pad 120 can be made of any other suitable material (e.g., leather, etc.) that protects one or more wires 130 in the cover pad 120 and does not interfere with an electromagnetic field 180 generated by the one or more wires 130.

In further examples, one or more wires 130 in a cover pad 120 of an inductive loop pad 110 can generate an electromagnetic field 180 corresponding to sound received by a communication device 150. The intensity of the electromagnetic field 180 can be correlated to the intensity of the electric current in the one or more wires electrically coupled with a power amplifier 140. For example, the cover pad 120 can be wound with one or more turns of the one or more wires 130. In a non-limiting scenario, the one or more wires 130 can be one or more copper wires. However, the one or more wires 130 can include any other suitable material to generate an electromagnetic field. In a further scenario, the one or more wires 130 can include a coaxial or a flat wire.

In further examples, a power amplifier 140 in the communication system 100 can be electrically coupled with the one or more wires 130 to amplify and transfer an electrical audio signal 140 from a communication device 150 to the one or more wires 130. In a non-limiting scenario, the power amplifier 140 can be attached to the inductive loop pad 110. In another non-limiting scenario, the power amplifier 140 can be a detachable unit from the inductive loop pad 110. In a further scenario, the power amplifier 140 can be electrically coupled with the inductive loop pad 110 using a wire connection or a wireless connection. In an even further non-limiting scenario, the power amplifier 140 can be electrically coupled with one inductive loop pad 110 or more than one inductive loop pads 110 at the same time. In some instances, the power amplifier 140 can be a Class D amplifier. In further instances, the power amplifier 140 can use a battery (e.g., a pair of D cells or any other suitable electric cells for providing energy to the amplifier 140). In other instances, the power amplifier 140 can use power energy by accessing the mains electricity or some other source of energy. In one aspect, the connection between the amplifier 140, the communication device 150, and/or the hearing devices 170 may be open and unencoded, e.g., so that any hearing device 170 or communication device 150 may be able to quickly and easily operatively couple to the amplifier. In still another aspect, the connection may be encoded so as to provide greater security and/or privacy to the users with respect to their communications transmitted over the amplifiers. In some examples, the power amplifier 140 can utilize one or more communication channels to communicate with one or more groups of hearing devices 170. For example, the power amplifier 140 can transmit an electric current corresponding to an electrical signal from a communication device 150 with a communication channel to communicate with hearing devices 170 using the channel. Also, the power amplifier 140 can use a different channel to communicate with different hearing devices 170 using the different channel.

In even further examples, one or more communication devices 150 in the communication system 100 can convert sound to an electrical audio signal 160. For example, a communication device 150 can include or be electrically coupled to a microphone or a transducer for converting sound into an electrical audio signal 160. The converted electrical audio signal 160 can be fed into the amplifier 140 via a communication link (e.g., any suitable communication link or combination of communication links, such as wired links, fiber optic links, Wi-Fi links, Bluetooth® links, cellular links, etc.). In some scenarios, one or more communication devices 150 can be attached to the inductive loop pad 110. Thus, one or more people using the inductive loop pad 110 do not need to carry their personal communication devices 150. In other scenarios, one or more communication devices 150 can be separate units from the inductive loop pad 110 and can communicate with the power amplifier 140. For example, a communication device 150 can be located at any suitable place (e.g., clipped to a collar of a user or a mask of the user, placed on or under a table, etc.). Exemplary communication devices may be described in one or more of Dunn et al. U.S. Pat. No. 8,019,386, issued Sep. 13, 2011, Dunn. U.S. Pat. No. 8,150,057, issued Apr. 3, 2012, and/or Dunn U.S. Pat. No. 9,066,169, issued Jun. 23, 2015, the contents of each which are incorporated by reference herein in their entirety. In some examples, the one or more communication devices 150 in the communication system 100 can be at least two communication devices 150.

In even further examples, one or more hearing devices 170 in the communication system 100 can receive an electromagnetic field 180, which is generated from the one or more wires 130. In some instances, a hearing device 170 can include a coil to receive the electromagnetic field 180 and convert the electromagnetic field 180 into sound that a person wearing the hearing device 170 can hear. In a non-limiting scenario, a hearing device 170 can use a telecoil mode designed to receive and process the electromagnetic field 180. In another non-limiting scenario, a hearing device 170 does not have a telecoil mode but may receive and process the electromagnetic field 180 by default. For example, the hearing device 170 can always receive and process the electromagnetic field 180 without changing to the telecoil mode. In some instances, the hearing device can automatically change to the telecoil mode when the hearing device 170 detects the electromagnetic field 180. In a further scenario, a hearing device 170 may include a hum filter to reduce the hum interference (e.g., from wiring, fluorescent lights, etc.). For example, the hum filter in the hearing device 170 can mute an audio signal at the hum frequency (e.g., 50 or 60 Hz main frequency). In some examples, the hearing device 170 may include a sealed-ear earphone, an open-ear earphone, a t-coil earbud along with a concealed loop or any other suitable earphone to assist hearing of a user. Exemplary hearing devices, and additional exemplary communication devices, may be described in or may be used with the systems described in one or more of Cevette et al. U.S. Pat. No. 10,306,375, issued May 28, 2019, and/or Cevette et al. U.S. Pat. No. 10,560,786, issued Feb. 11, 2020, the contents of each which are incorporated by reference herein in their entirety.

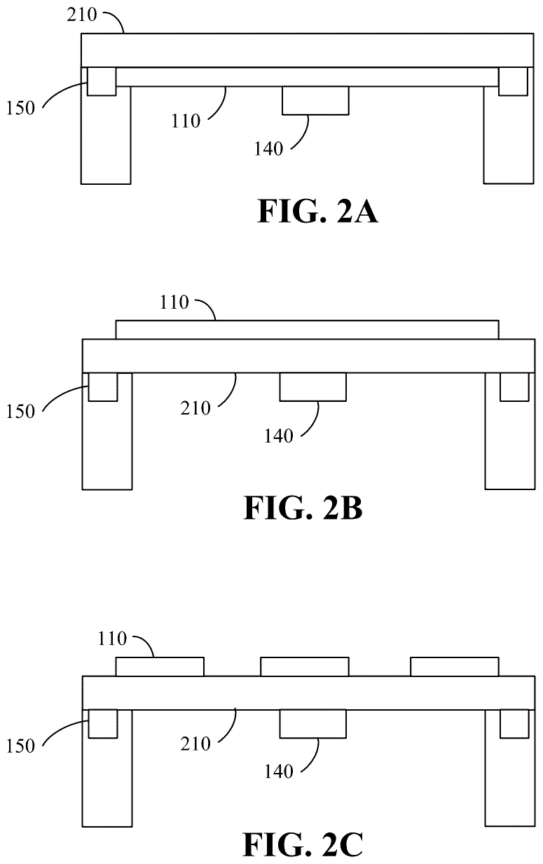

FIGS. 2A-2C are conceptual illustrations of examples of a communication system installed on a table according to some embodiments. In FIG. 2A, an inductive loop pad 110 can be installed on a bottom surface of the top of a table 210. Since the inductive loop pad 110 is hidden under the table, the inductive loop pad 110 can generate an electromagnetic field to cover hearing devices for people sitting around the table 210 while people on the table are not aware of the inductive loop pad 110. In some examples, one or more communication devices 150 also can be installed on a bottom surface of the top of the table 210. In a non-limiting scenario, a communication device 150 can be placed or fixed on the table 210 in front of each chair to suitably pick up a voice of a person sitting on the respective chair. In another non-limiting scenario, one or more communication devices 150 can be placed or fixed at or near the center of the table 210 to receive voices of people sitting around the table 210. It should be appreciated that one or more communication devices 150 can be placed or fixed at any other suitable place. For example, each person can use a personal communication device clipped on their clothing, e.g., on or near a shirt collar or on or near a mask or other facial covering. A power amplifier 140 can receive an electrical audio signal from the communication device 150 and generate an electrical current corresponding to the audio signal for the inductive loop pad 110 to generate an electromagnetic field. When the one or more communication devices 150 are fixed on the table 210, the one or more communication devices 150 can be connected to the power amplifier 140 using a wired connection. However, it should be appreciated that the one or more communication devices 150 can be wirelessly coupled with the power amplifier 140. In some examples, multiple inductive loop pads 110 can be installed on the bottom surface of the top of the table. One power amplifier 140 can connected to or electrically coupled with the multiple inductive loop pads 110. In other examples, at least two power amplifiers 140 can connect to or be electrically coupled with multiple corresponding inductive loop pads 110.

In FIG. 2B, an inductive loop pad 110 can be placed on a top surface of the top of a table 210. For example, the inductive loop pad 110 can be placed under the tablecloth at the location around the table where a couple of people using hearing devices are invited to sit. In some examples, the inductive loop pad 110 can be portable such that the inductive loop pad 110 can be placed on the table 210 and can be removed when the inductive loop pad 110 is not in use or moved to a different location around the table if the individual(s) requiring hearing assistance desire to sit at a different location from where it is originally placed. It should be understood that one or more communication devices 150 and a power amplifier 140 can be placed or fixed at any suitable place (e.g., on a table, etc.), such as the locations described above with respect to FIG. 2A.

In FIG. 2C, multiple inductive loop pads 110 can be placed on a top surface or a bottom surface of the top of a table 210. For example, multiple inductive loop pads 110 (e.g., 2, 3, 4, or any other suitable number of inductive loop pads 110) can be placed or fixed on an upper surface of the table 210 under a tablecloth to generate an electromagnetic field strong enough for a hearing device to receive and process the electromagnetic field. One or more communication devices 150 and a power amplifier 140 can be placed at any suitable place (e.g., on a table, etc.), such as the locations described above with respect to FIG. 2A.

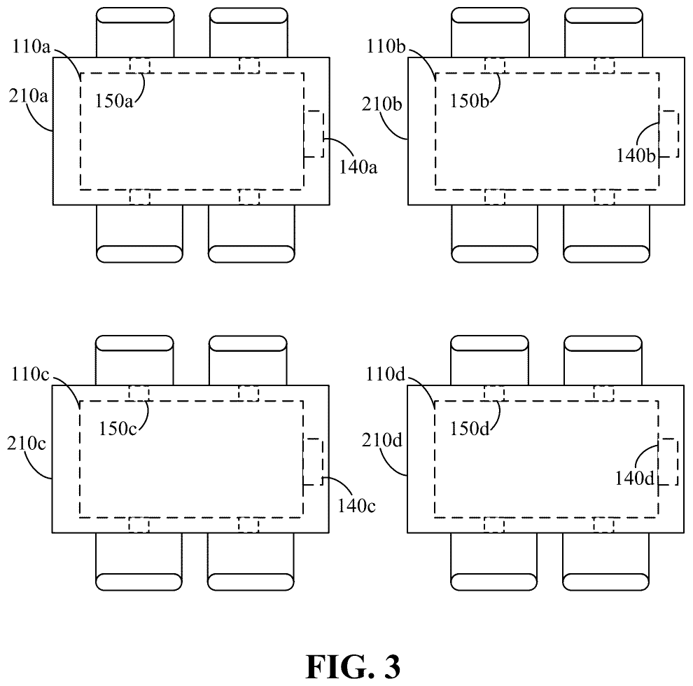

FIG. 3 is a conceptual illustration of an example of a communication system installed on multiple tables according to some embodiments. For example, multiple inductive loop pads 110a, 110b, 110c, 110d can be installed on multiple corresponding tables 210a, 210b, 210c, 210d. As described above in connection with FIG. 2A-2C, an inductive loop pad 110a, 110b, 110c, 110d can be installed, placed, or fixed on any suitable place on the table 210a, 210b, 210c, 210d. In some examples, multiple communication devices 150a, 150b, 150c, 150d can be installed on each table 210a, 210b, 210c, 210d and/or electrically or operatively coupled to respective loop pads 110a, 110b, 110c, 110d. In further examples, each communication device 150a, 150b, 150c, 150d can be placed to suitably receive a voice of a person in a table 210a, 210b, 210c, 210d. In some scenarios, a first inductive loop pad 110a can generate a first electromagnetic field to communicate with one or more hearing devices for people around a first table 210a. A second inductive loop pad 110b can generate a second electromagnetic field to communicate with one or more hearing devices for people around a second table 210b. In this way, each inductive loop pad can generate a specific electromagnetic field to communicate with a predefined group of hearing devices. For example, the specific electromagnetic field can carry a channel-specific signal for the predefined group of hearing devices to communicate with the inductive loop pad along with the channel signal. Thus, hearing devices with another channel or for people at another table may not process the electromagnetic field with the channel. In other examples, the inductive loop pad can generate an electromagnetic field not strong enough to travel to hearing devices around another table. For example, the size or shape of the wire in the inductive loop pad can be designed considering the distance to another table. In further examples, a power amplifier 140a, 140b, 140c, 140d can control the intensity of the current to be transmitted to the wire in the inductive loop pad 110a, 110b, 110c, 110d.

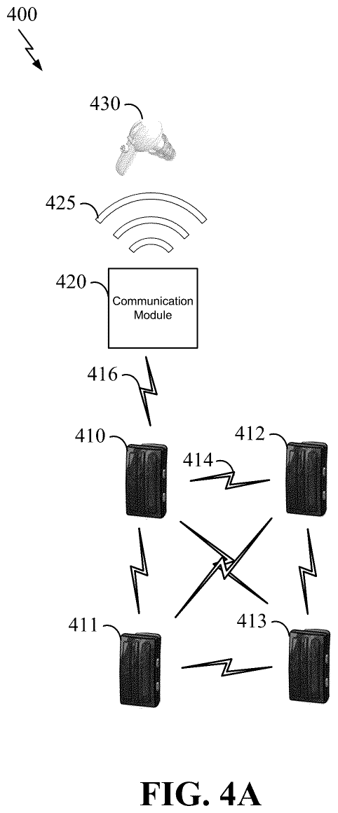

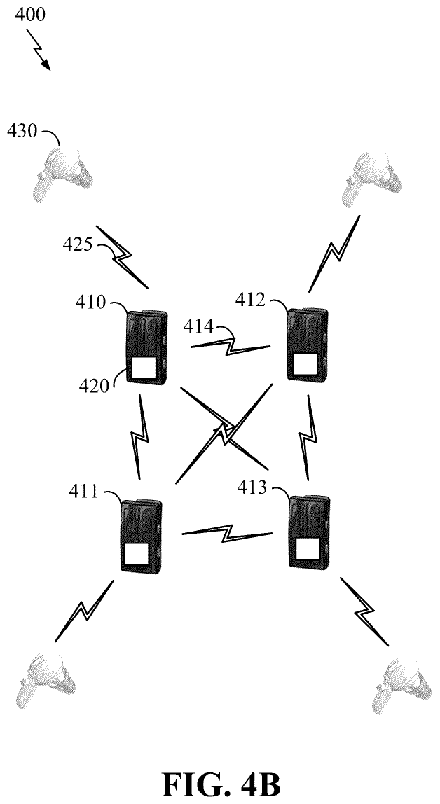

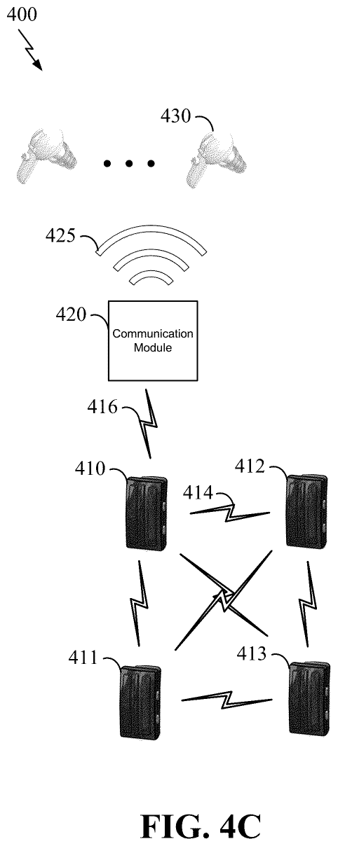

FIG. 4A is a conceptual illustration of an example of a communication system using a communication protocol according to some embodiments. A communication system 400 can include one or more communication devices 410-413, a communication module 420, and one or more hearing devices 430. For example, one or more communication devices 410-413 in a group can receive sound and convert sound to an electrical audio signal. Each of the one or more communication devices 410-413 in the group can send an electrical audio signal 414 to each other 410-413 in the same group and combine electrical audio signals from other communication device(s). Then, the combined electrical audio signal 416 can be transmitted to the communication module 420. In some examples, the communication module 420 can send the combined electrical audio signal or modulate the combined electrical audio signal 416 to be suitable for a communication protocol. Then, the communication module 420 can transmit the combined or modulated electrical audio signal 416 to one or more hearing devices 430. Thus, the communication module 420 can be a means of sending the combined electrical audio signals of the one or more communication devices 410-413 to the one or more hearing devices 430. A hearing device 430 can receive the modulated electrical audio signal 425 and convert the modulated electrical audio signal 425 to the sound. Since the modulated electrical audio signal 425 contains all sound from the one or more communication devices 410-413 in the group, a person wearing the hearing device 430 in his/her ear can hear the sound received by all of the one or more communication devices 410-413 in the group.

For example, a group can include a first communication device 410 and a second communication device 412. It should be appreciated that the group is not limited to the first and second communication devices 410, 412. For example, the group can further include a third communication device 411, and a fourth communication device 413. In some examples, the group can include four communication devices 410-413 or any other suitable number of communication devices. For example, the first and second communication devices 410, 412 (which can be any other communication devices 410-413) can receive sound and convert the sound to a first electrical audio signal and a second electrical signal, respectively (e.g., via microphones of the first and second communication devices 410, 412). The second communication device 412 can transmit the second electrical audio signal (e.g., packet in time slot) to the first communication device 410 (e.g., via a transceiver of the second communication device 412). The first communication device 410 can receive the second electrical audio signal (e.g., via a transceiver of the first communication device 410) and combine the first electrical audio signal and the second electrical audio signal to generate a combined electrical audio signal 416 (e.g., using frequency hopping and packet switching, and/or a unique pseudo random sequence for the group including the first and second communication devices 410, 412). Similarly, when the group includes four communication devices, each communication device 410-413 receive can transmit its electrical audio signal to other communication devices and receive other electrical audio signals to combine the electrical audio signals and its electrical audio signal. The combined electrical audio signal 416 can be transmitted (e.g., via the transceiver of the first communication device 410) to the communication module 420 (e.g., an audio output jack). Thus, the communication module 420 can receive the combined electrical audio signal 416, which is the combined output from any one or the one or more communication devices 410-413 and generate a communication signal using a communication protocol (e.g., the Wi-Fi protocol, the Bluetooth® protocol, a cellular protocol, etc.). The communication module 420 can transmit the communication signal to one or more hearing devices 430. The more detailed description for each component of the communication system 100 is presented below.

In some examples, one or more communication devices 410-413 in the communication system 400 can convert sound to an electrical audio signal. The one or more communication devices 410-413 can communicate with each other. For example, each communication device 410-413 can include or be electrically coupled to a microphone (not shown) for converting sound into an electrical audio signal. The communication device 410-413 can transmit the converted electrical audio signal 414 to other communication device(s) 410-413. The communication device 410-413 can combine all electrical audio signals 414 from the communication device and other communication device(s) 410-413 (e.g., using frequency hopping and packet switching, and/or a unique pseudo random sequence for the group including the communication device and other communication device(s)). For example, each communication device can send out its signal in its own time slot (and its own frequency hop), receive each signal of the other communication devices, and combine signals on corresponding time slots to generate a combined signal. Then, the communication device 410-413 can transmit the combined electrical audio signal 416 to the communication module 420 via a communication link (e.g., any suitable communication link or combination of communication links, such as wired links, fiber optic links, Wi-Fi links, Bluetooth® links, cellular links, etc.). For example, the communication device 410-413 can include a 3.5 mm stereo socket earphone jack, and the communication module 420 can be included in a phone (e.g., iPhone® or android phone) having a connector (e.g., Lightning® connector or USB-C connector). The communication link can be a cable having a 3.5 mm stereo jack to be connected to the communication device 410-413 and a phone connector (e.g., Lightning® connector or USB-C connector) connected to the communication module 420. However, it should be appreciated that the communication link is not limited to a wired link. The communication link between the communication device 410-413 and the communication module 420 can be a wireless link (e.g., Wi-Fi links, Bluetooth® links, cellular links, etc.). Exemplary communication devices 410-413 may be described in one or more of Dunn et al. U.S. Pat. No. 8,019,386, Dunn U.S. Pat. No. 8,150,057, and/or Dunn U.S. Pat. No. 9,066,169, the contents of each which are incorporated by reference herein in their entirety. In some examples, the communication devices 410-413 can include at least some of the functionality and/or components of communication devices known commercially as Companion Mics™ or C-Mics™. However, it should be appreciated that the communication devices 410-413 should not be limited to these specific devices but may include, e.g., other devices that include similar functionality.

In further examples, the communication module 420 in the communication system 400 can include an electrical circuit to receive the combined electrical audio signal 416 from the communication device 410-413 and transmit the combined electrical audio signal 416 to one or more hearing devices 430. In some examples, there are multiple communication modules corresponding to multiple communication devices 410-413. In such examples, each communication module 420 can receive the combined electrical audio signal 416 from a respective communication devices 410-413. In some examples, the communication module 420 can use the electrical circuit or a separate electrical circuit to modulate the combined electrical audio signal 416 to generate a communication signal, which is suitable for communications using a predetermined communication protocol with one or more hearing devices. For example, the communication module 420 can use a short-range wireless communication protocol (e.g., Bluetooth®, Wi-Fi, ZigBee, Ultra Wide Band (UWB), Infrared (IR), NFC, etc.) for the communication signal and communicate with one or more hearing aids or other hearing or listening devices 430 using the short-range wireless communication protocol. For example, The communication module 420 can modulate the combined electrical audio signal 416 to generate an ultra-high frequency radio signal (i.e., the communication signal) in the Bluetooth® frequency band (e.g., 2.402 GHz to 2.48 GHz). However, it should be appreciated that the communication protocol to communicate with one or more hearing devices 430 is not limited to the short-range wireless communication protocol. For example, the communication module 420 can communicate with one or more hearing devices 430 using a mid-range wireless communication protocol (e.g., ZigBee, Thread, Z-Wave, Wi-Fi, etc.), a long-range wireless communication protocol (e.g., cellular, LoRaWAN, etc.), or any other suitable communication protocol.

In some instances, the communication module 420 can receive more than one electrical audio signal 416 from more than one communication device 410-413. In some examples, the communication module 420 can be included in a suitable device (e.g., mobile device, Apple® iPhone®, Android phone, smart watch, or any other suitable device which can include the communication module 420). The communication module 420 can be communicatively coupled to a communication device using a wired connection (e.g., via a cable including be a USB-C cable, a Lightning® charger cable, or any suitable cable) or a wireless connection (e.g., using a short-range, mid-range, or long-range wireless communication protocol). In some examples, communication devices 410-413 can be communicatively coupled to corresponding communication modules or one or more communication modules.

In other examples as shown in FIG. 4B, the communication module 420 can be included in a communication device 410-413. Then, the communication device 410-413 can receive the sound, convert the sound into an electrical audio signal, combine the electrical audio signal with other electrical audio signals from other communication device(s) 411-413, modulate the combined electrical audio signal 425, and transmit the modulated or combined electrical audio signal 425 to one or more hearing devices 430 using the communication module 420. In such examples, the communication module 420 can be a short-range communication module (e.g., Bluetooth® module, etc.), a mid-range communication module, or a long-range module. For example, each communication device 410-413 can contain a separate and individual low energy Bluetooth connection to its wearer's individual hearing aid 430 or, if a multipoint transceiver is employed, to several hearing aids. In further examples, a communication device 410-413 with a communication module 420 can be communicationally coupled to one hearing aid 430 or multiple hearing aids 430 at the same time. In some examples, a housing can include the communication device 410-413 and the communication module 420. In further examples, the communication device 410-413 and the communication module 420 are included in a separate device (e.g., mobile device). In some examples, the communication device 410-413 can communicate with a corresponding and paired hearing aid 430. Thus, each communication device 410-413 can communicate with other communication devices 411-413 to generate a combined electrical audio signal 425 and transmit, via the communication module 420, the combined electrical audio signal 425 to a hearing device 430, which is communicationally paired and coupled with the respective communication device 410-413. In other examples, the communication device 410-413 can communicate with more than one hearing aid 430.

In even further examples, such as the examples shown in FIGS. 4A-4C, one or more hearing devices 430 in the communication system 400 can receive a modulated or combined electrical audio signal 425 from a communication module 420 and convert the modulated or combined electrical audio signal 425 to sound for one or more hearing device users. The modulated or combined electrical audio signal 425 can contains all sound from the one or more communication devices 410-413. In some examples as shown in FIG. 4A or 4B, a hearing device 430 can include a communication module to detect a modulated or combined electrical audio signal 425 from the communication module 420. Thus, when the communication module 420 transmits a modulated electrical audio signal 425 using the Bluetooth protocol, the hearing device 430 can include a corresponding communication module to process the modulated electrical audio signal 425 using the Bluetooth protocol.

In some examples, such as the example shown in FIG. 4A, the communication module 420 (e.g., a mobile device or any suitable communication module to transmit an electrical audio signal) can receive the modulated or combined electrical audio signal 416 from the corresponding communication device 410 (e.g., via a cable connecting the communication device 410 to the communication module 420) and transmit the combined electrical audio signal or the converted signal according to a communication protocol to one corresponding or paired hearing aid 430. In further examples, such as the example shown in FIG. 4B, the communication device 410-413 can transmit the combined electrical audio signal or a converted signal 425 according to a communication protocol to one corresponding or paired hearing aid 430. In even further examples, such as the example shown in FIG. 4C, the communication module 420 (e.g., an inductive loop, an FM transmitter, or any suitable communication module to transmit an electrical audio signal) can receive the modulated or combined electrical audio signal 416 from the corresponding communication device 410 (e.g., via a cable connecting the communication device 410 to the communication module 420) and transmit the combined electrical audio signal or the converted signal according to a communication protocol to multiple hearing aids 430 (e.g., telecoil hearing aids or any other suitable hearing aids having an acceptable receiver to process the signal). In such examples, more than one hearing device 430 can receive the same modulated or combined electrical audio signal 425 from the communication module 420 and convert it to the sound. Accordingly, all hearing device users can listen to the same sound in their respective hearing devices substantially concurrently.

Exemplary hearing devices 430, and additional exemplary communication devices 410-413 in FIGS. 4A-4C, may be described in or may be used with the systems described in one or more of Cevette et al. U.S. Pat. No. 10,306,375 and/or Cevette et al. U.S. Pat. No. 10,560,786, the contents of each which are incorporated by reference herein in their entirety. In some examples, the hearing devices 430 can include at least some of the functionality and/or components of communication devices known commercially as HearHooks™, HHearBuds™ (e.g., K-AMP HHearBuds™, T-Coil HHearBuds™). However, it should be appreciated that the hearing devices 430 should not be limited to these specific devices but may include, e.g., other devices that include similar functionality.

In some examples, a communication system 400 can include multiple communication devices 410-413 in wireless radio frequency (RF) communication with one another. In some examples, the wireless RF communication can be a 2.4 GHz communication. Each communication device 410-413 can include a microphone configured to convert sound from a respective user to an electrical audio signal, and a wireless transmitter to transmit the electrical audio signal to each of the other communication devices. The communication system can further include a communication module communicatively couple to one of the communication devices. The communication module can be configured to receive the electrical audio signals from the microphone of the communication device to which it is communicatively coupled and the electrical audio signals transmitted to the communication device to which it is coupled. In some examples, the communication module can be communicatively coupled to the one of the communication devices via a wireless connection. In other examples, the communication module can be communicatively coupled to the one of the communication devices via a wired connection. In the examples, the communication module 420 is a cellular telephone, and the wired connection can be via a cable configured to electrically couple to the communication device. In some scenarios, the cable can be a USB-C cable or a Lightning® charger cable. In other scenarios, the cellular telephone can be an iPhone®, and the cable can be configured to electrically couple to the iPhone®. The communication system 400 can further include one or more hearing devices 430 configured to receive the communication signal using a communication protocol. In some examples, the communication protocol can be Bluetooth.

In further examples, a communication system 400 can include multiple communication devices 410-413 in wireless radio frequency (RF) communication with one another. In some examples, the RF communication is a 2.4 GHz communication. The multiple communication devices 410-413 can include a first communication device 410 (or one of any other communication devices 411-413) including a microphone configured to convert sound from a user to an electrical audio signal and a wireless transmitter to transmit the electrical audio signal via the RF communication to each of other communication devices 411-413 including a second communication device 412. In some examples, the electrical audio signal can be a combined electrical audio signal with another electrical audio signals from the other communication device 411-413. The communication system 400 can further include a communication module communicatively coupled to the second communication device 412 (or one of any other communication devices 410, 411, 413). The communication module can be configured to receive the electrical audio signal 416 from the second communication device 412. In some examples, the communication module can be communicatively coupled to the second communication device 412 via a wireless connection. In other examples, the communication module can be communicatively coupled to the second communication device 412 via a wired connection. In some scenarios, the communication module can be a cellular telephone, and the wired connection can be via a cable configured to electrically couple to the cellular telephone. In further scenarios, the cable can be a USB-C cable. In other scenarios, the cellular telephone can be an iPhone®, and the cable can be configured to electrically couple to the iPhone®. The communication system 400 can further include one or more hearing devices 430 configured to receive the communication signal using a communication protocol. In some examples, the communication protocol is Bluetooth.

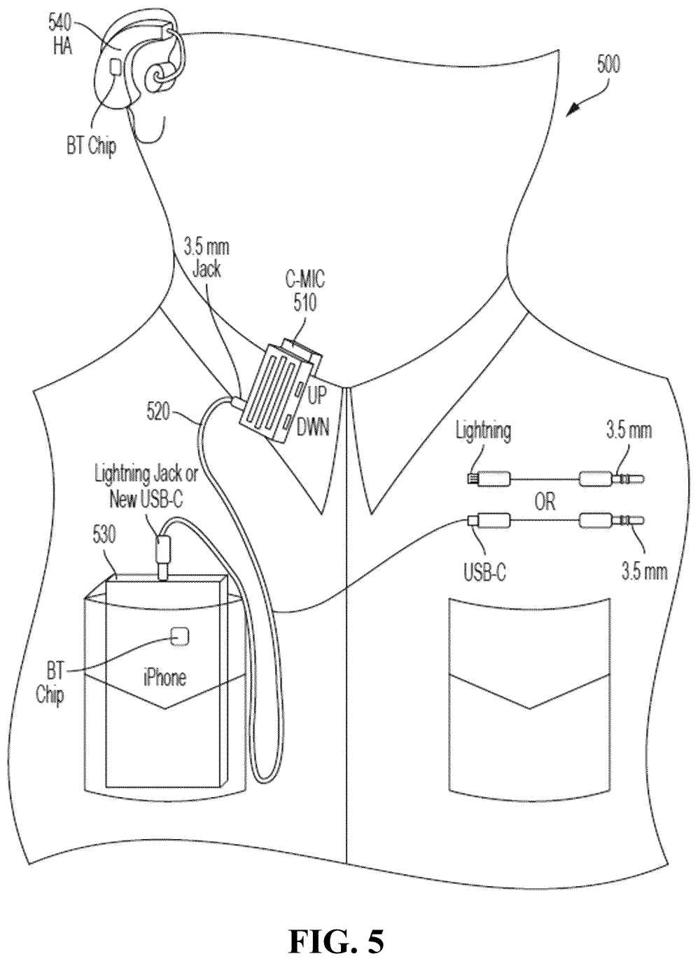

FIG. 5 is a conceptual illustration of an example of a communication system using a phone according to some embodiments. In some examples, a communication device 510 can be clipped to a collar of a user or a mask of the user to receive the sound from the user. The communication device 510 can receive other electrical audio signal(s) from other communication device(s) in the same group and combine the electrical audio signal from the user and other electrical audio signal(s) from other communication device(s). In a non-limiting scenario, the communication device 510 can include a connector (e.g., 3.5 mm socket) to output an electrical audio signal combining electrical audio signal(s) from any one of the communication device(s) in the group. In a further scenario, a cable 520 can transfer the electrical audio signal from the communication device 510 to a phone 530. The phone may include a connector (e.g., Lightning® for iPhone® and USB-C for Android phone) to connect to the cable 520 and receive the electrical audio signal from the communication device via the cable 520. Thus, one end of the cable 510 can include a male connector (e.g., 3.5 mm jack) to be coupled with the communication device 510, and the other end of the cable 520 can include another male connector (e.g., Lightning® or USB-C connector) to be coupled with the phone 530. The phone 530 can include a communication module (e.g., Bluetooth module) to modulate the electrical audio signal to generate and transmit a communication signal (e.g., Bluetooth signal) to one or more hearing devices 540, which also include a corresponding communication module (e.g., Bluetooth module) to receive and process the communication signal from the phone 530. In some examples, a small pouch can house the communication device 510 and the phone 530 to prevent “pocket dial” interference. The one or more hearing devices 540 can convert the communication signal to the sound that the user can hear. It should be appreciated that the communication device 510, the cable 520, the phone 530, and the hearing device 540 are non-limiting examples.

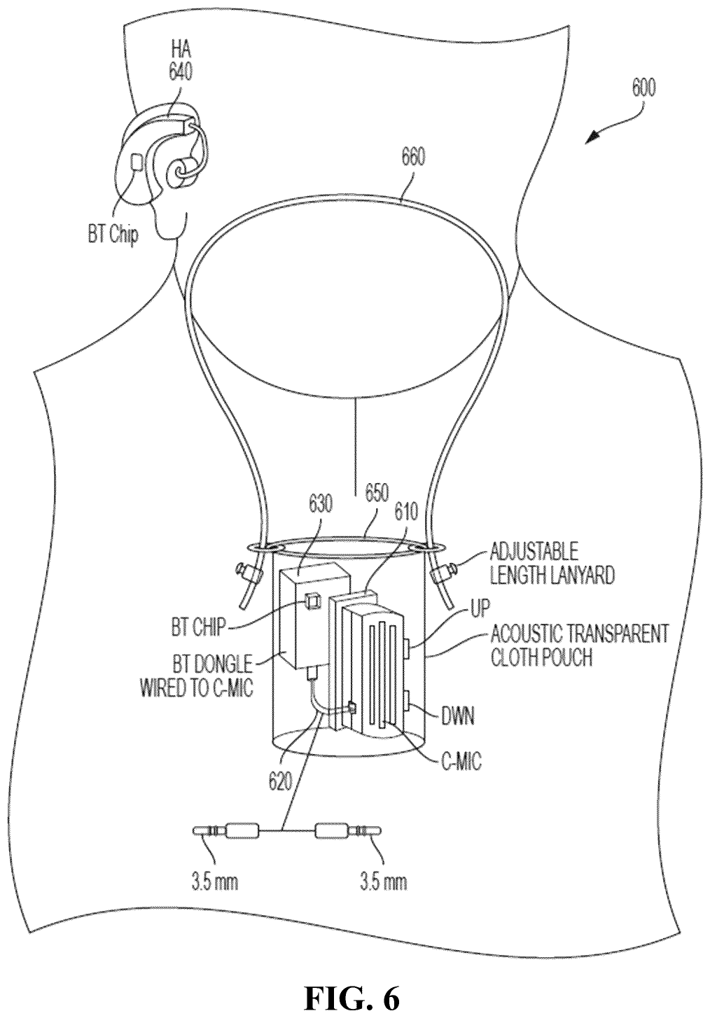

FIG. 6 is a conceptual illustration of an example of a communication system using a transmitter according to some embodiments. In some examples, a communication device 610, a cable 620, and a hearing device 640 are substantially similar to the communication device 510, the cable 520, and the hearing device 540 in FIG. 5. FIG. 6 uses a transmitter 630 rather than a phone 530 in FIG. 5. The transmitter 630 can include a communication module. The transmitter 630 can be a dongle to receive an electrical audio signal from the communication device 610, generate a communication signal under a communication protocol (e.g., Bluetooth), and transmit the communication signal using the communication protocol to one or more hearing devices 640. In some examples, a small pouch 650 can house the communication device 510 and the transmitter 630. In further examples, a band 660 can be used to hold the small pouch 650 including the communication device 610 and the transmitter 630 in close proximity to the user's mouth to clearly detect the sound from the user. It should be appreciated that the communication device 610, the cable 620, the transmitter 630, the hearing device(s) 640, the pouch 650, and the band 660 are non-limiting examples.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

An inductive loop pad coupled to (or positioned under) a table, an amplifier (e.g., a power amplifier) that can power the inductive loop pad, and a microphone (e.g., a companion microphone in “listen only” mode) that can provide an input to the amplifier.

Use of the microphone with a communication device with an inductive loop pad in each frequent location, as suggested below. The cost would be relatively trivial.

For example, separable or integrated kits ready for installation can include: a microphone, a power amplifier, and an inductive loop pad for under that table or wherever.

Some small Class D amplifier units can be used for the power amplifier. In some examples, the small Class D amplifier units can operate for 32 hours on a pair of D cells. However, it should be appreciated that any other suitable amplifier or battery can be used. In further examples, a battery case to cover the power amplifier with the battery can be included.

Since the loop is under the table, it does not require a neckloop hidden under the shirt. The microphone can be clipped on the collar and connected to a hearing device. That means no fumbling with+ and −gain buttons on the microphone. In some examples, each microphone can have middle-gain (#5). In further examples, a hearing device can include a volume control for a user to easily adjust the volume of the hearing device.

In some examples, frequently used locations (e.g., restaurants, etc.) can include the same lot number as the four active ones used for the microphones. The microphone can use the microphone (e.g., with a 2.6 GHz power/antenna unit) with the hearing devices.

In some examples, there may be no limit to the number of hearing devices that may be used with the loop, as long as each hearing device is programmed to the same RF round-robin switching sequence. So it would be possible to have multiple hearing devices, a power amp, and an inductive loop pad that the user could leave plugged in at home, office, restaurant, poker place, etc. In a non-limiting scenario, the audio signal used in the communication system is encoded, so no one else could use it.

In some examples, the communication between the inductive loop pad/power amplifier and the hearing devices can use the Bluetooth protocol without using the coils in the hearing devices.

In some examples, using the speed of light, a cancelling magnetic hum field signal can be sent. Thus, all the hearing aids with telecoil (most of them) could operate in restaurant booths without needing hearing devices without a hum filter.

As previously described, a suitable place (e.g., restaurant booth, etc.) can use an inductive loop pad under the table, a power amplifier, and a microphone under the table.

In some examples, multiple microphones (e.g., four or any other suitable number of microphones) can pick up the signals from multiple people at the table.

In some examples, one or more hearing devices can listen in if they had been programmed to the same digital identification to communicate with the one or more microphones under the table. Each person at the table can wear a communication device which functions as a microphone only (although the user that carries a wired earphone can plug that into the hearing device.

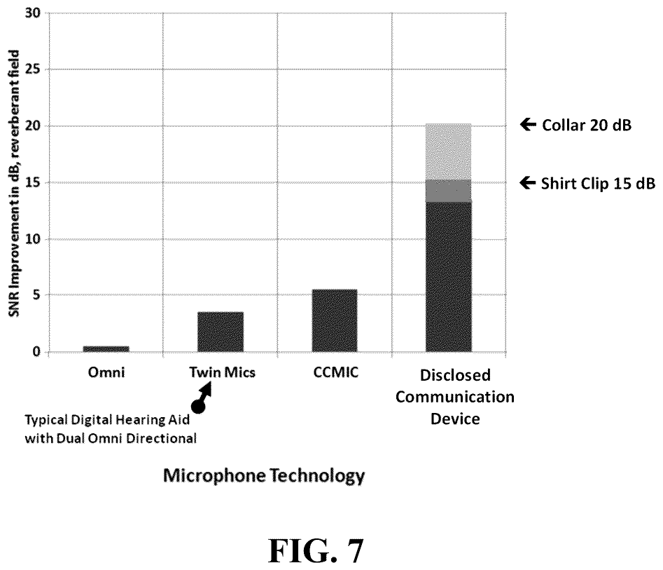

FIG. 7 is a comparison of signal-to-noise ratio (SNR) for the disclosed communication system with other existing hearing devices. In an experiment, the communication device 150, 410 on a shirt clip and a collar with the hearing device 170, 430 showed an SNR improvement of 20 dB and 15 dB, respectively, while other existing hearing devices showed less than 6 dB.

### A: Examples for Those Wearing Hearing Aids

The open-ear earphones can employ a high-fidelity sound tube with a bendable wire inside. The open end of the open-ear earphone can be adjusted as shown below to be near the entrance of the ear canal. With this adjustment, open-ear listening is possible while retaining nearly a 14 dB relative noise reduction. When this tube can be substituted for a telecoil earbud internal earphone, it might allow coupling to the wearer's hearing aids by re-bending the tube to place the outlet near the hearing aid microphone.

A face mask is also a convenient place to clip on a communication device 150, 410 (e.g., a microphone or transducer). That location is only some 3″ from the mouth, which provides an estimated 6 dB increase in signal compared to clipping the unit to the collar. This location brings the expected “total relative noise reduction” back up to 19 dB: Nearly identical to the 20 dB measured from the combination of collar the communication device 150, 410 and sealed-ear earphones or a hearing device.

For those using hearing aids, try switching to the “telecoil” mode. Many popular locations have low enough Magnetic Hum levels—from 110V bad wiring or the like—that with the strong field provided by the t-coil signal levels in a booth location no additional hum filter is required: In that case, the hearing device can be simply switched to telecoil. In many cases a measurement (or simply listening with a hearing aid switched to telecoil) may find a booth location in the restaurant where there is a low hum level.

In some examples, the hum level in restaurants and the like is fairly constant over a 10-20-foot location. When that is true, it may be possible to add a hum canceling magnetic field that would cover that same area. Since the hum field may stay in phase, it may be possible to introduce a canceling hum signal into the inductive loop. The magnetic hum travels at the speed of light, so the cancellation can work over a surprisingly large area.

### B. Examples for More than Four Talkers at a Larger Table

If there are more than 4 people at the table, up to 12 talkers could be heard clearly if the non-wearer person simply leans over and talks near the microphone clipped on to the collar of a nearby person. Even a “casual lean” should bring the talker to within 12 to 18″ from the microphones, instead of the normal 5-6 inches. A quick experiment suggests a 10 dB or less loss in level. The communication system can provide a 20 dB improvement with sealed earphones, but even 10 dB is adequate in most circumstances: The best modern hearing aids give less than 5 dB at most, some much less. Indeed, half of the six hearing aids recorded in a 2015 Northwestern University experiment gave better intelligibility if they were taken off. The best of the other three gave only a 1.5 dB effective noise reduction.

In some examples, multiples of 4-unit microphone sets can be distributed as long as the corresponding microphones were under the table. Each set of microphones has a unique code, and no eavesdropping is allowed. The original and the additional microphones can be fed into an inexpensive automatic microphone mixer whose output would provide the input to the loop power amplifier. The microphone mixer (e.g., Shure) can allow only the prominent signal to be passed through, so the average noise level would be no higher than that of an individual set of four.

In some examples, the inductive loop pad can be a 36″×20″ vinyl pad wound with several turns of copper wire. For family gatherings, it can be placed under the tablecloth at the location where a couple people with trouble hearing in noise are invited to sit. Actually, more than two hard-of-hearing family members can be accommodated if two or more loops are used. This can be all driven by the same amplifier and microphones under the table. For home applications, the hum filter may be required, even in some not-so-old houses where the wiring was not installed with the goal of reducing telecoil him pickup. In some restaurants where no hum problem occurs, the hearing device does not need the hum filter. In one case, the hum issue can be avoided in choosing the booth or table for loop installation.

14 dB noise reductions were experienced when the system included a communication device 150, 410 clipped to the collar. If the communication device 150, 410 is held close to the mouth (as in the case, e.g., of a CountryMan-type mic such as those frequently worn by priests or preachers), then an improvement of 20 dB or more is easily obtained. Additionally, in venues such as churches and synagogues and theatres, the audiences are usually quiet, but the reverberation time in a large space can easily exceed 1.5 Seconds (RT60, the time it takes for the reverberation of a very loud signal to become inaudible). Several studies have indicated that 1.5 seconds RT60 is sufficient to case a loss of “signal to noise” ratio of 10 dB. Those with normal hearing can still understand, but someone who already has a 10 dB auditory “SNR” deficit will be unable to do so. In this case, enough noise reduction can be provided using the present system to overcome that problem.

What is claimed is:

1. A communication system comprising:
a first communication device in wireless radio frequency (RF) communication with a second communication device, the first communication device including a microphone configured to convert sound from a user to a first electrical audio signal, and a wireless transceiver to receive a second electrical audio signal from the second communication device and transmit a combined electrical audio signal of the first electrical audio signal and the second electrical audio signal to a communication module;
the communication module communicatively coupled to the first communication device, the communication module configured to receive the combined electrical audio signal from the first communication device, generate a communication signal based a communication protocol, and transmit the communication signal to one or more hearing devices; and
the one or more hearing devices configured to receive the communication signal using a communication protocol.

2. The communication system of claim 1, wherein the first communication device is configured to combine the first electrical audio signal and the second electrical audio signal using frequency hopping and packet switching to generate the combined electrical audio signal.

3. The communication system of claim 1, wherein the communication module is communicatively coupled to the first communication device via a wireless connection.

4. The communication system of claim 1, wherein the communication module is communicatively coupled to the first communication device via a wired connection.

5. The communication system of claim 4, wherein the communication module is a cellular telephone, and wherein the wired connection is via a cable configured to electrically couple to the cellular telephone.

6. The communication system of claim 5, wherein the cable is a USB-C cable.

7. The communication system of claim 1, wherein the RF communication is a 2.4 GHz communication.

8. The communication system of claim 1, wherein the communication protocol is a short-range wireless protocol.

9. A communication system comprising:
a plurality of communication devices in wireless radio frequency (RF) communication with one another, the plurality of communication devices including a first communication device configured to convert sound from a user to a first electrical audio signal and transmit the first electrical audio signal via the RF communication to a second communication device;
a communication module communicatively coupled to the second communication device, the communication module configured to receive a combined electrical audio signal of the first electrical audio signal of the first communication device and a second electrical audio signal of the second communication device from the second communication device, and generate a communication signal using a communication protocol; and
one or more hearing devices configured to receive the communication signal using the communication protocol.

10. The communication system of claim 9, wherein the second communication device is configured to combine the first electrical audio signal of the first communication device and the second electrical audio signal of the second communication device using frequency hopping and packet switching to generate the combined electrical audio signal.

11. The communication system of claim 9, wherein the communication module is communicatively coupled to the second communication device via a wireless connection.

12. The communication system of claim 9, wherein the communication module is communicatively coupled to the second communication device via a wired connection.

13. The communication system of claim 12, wherein the communication module is a cellular telephone, and wherein the wired connection is via a cable configured to electrically couple to the cellular telephone.

14. The communication system of claim 13, wherein the cable is a USB-C cable.

15. The communication system of claim 9, wherein the RF communication is a 2.4 GHz communication.

16. The communication system of claim 9, wherein the communication protocol is a short-range wireless protocol.
